(19) United States
(12) Patent Application Publication
(10) Pub. No.: US 2005/0223338 A1
(43) Pub. Date: Oct. 6, 2005

(54) Animated user-interface in electronic devices

(75) Inventor: Minna Partanen, Oulu (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/818,444

(22) Filed: Apr. 5, 2004

(51) Int. Cl. G06F 3/00

(52) U.S. Cl. 715/821; 715/705; 715/711; 715/715; 715/822; 715/823

(57) ABSTRACT

A method for displaying a message on an electronic device. The device has a display screen to display one or more menu items, allowing a user to highlight the menu items by scrolling the menu. When a menu item is highlighted, a text message is displayed on a designated area in a scrolling motion if the text message exceeds the designated area. When the text message is short, it is possible to display the message at once or as a time sequence. The text message reflects updated information if the information pertaining to the highlighted menu item includes a current status, current events, or future events. Information pertaining to the layer lying below the displayed menu is shown without requiring the user to select an item on the displayed menu. If an icon associated with a menu item is also displayed, the icon may be animated when the menu item is highlighted.

### FIELD OF THE INVENTION

The present invention relates generally to the user-interface of an electronic device and, more specifically, to the icons displayed on the display screen of the electronic device.

### BACKGROUND OF THE INVENTION

On a portable electronic device, such as a mobile phone, a communicator device, or a personal digital assistant (PDA), a plurality of application names or icons are displayed on a display screen to allow a user to select an application. For example, a PDA usually has an application name called “Calculator” among a displayed list of application names to allow a user to access to a “Calculator” for simple arithmetic calculations. As applications contain more and more complex features, a user may have to try out a number of different application names before reaching the desired application.

Currently, a help text is used to explain a function associated with a “button” of the display screen or a feature associated with a menu name or icon. A button is usually defined as a designated area on the screen to allow a user to activate a function. An icon is usually defined as a graphical representation of an application to allow a user to launch the associated application. For example, when a user scrolls the menu, a menu name and an icon are shown on the screen. When the user stops scrolling, after a small time-out, the menu icon is animated. If the user remains at the same stage, a help text containing a fixed message is shown on the screen. The help text is usually shown on a “text bubble” or a designated area on the screen adjacent to the icon. When more complex features are implemented on an electronic device, especially on a portable electronic device with a small display screen, the static help text may not be sufficient to guide the user through all the different applications available on the device.

It is desirable and advantageous to provide a method for improving the user-interface regarding application names and icons so as to help the user to find the relevant applications.

### SUMMARY OF THE INVENTION

The present invention provides a method of improving the user interface on an electronic device by providing dynamic information to a user when the user points to an application shown on the user interface. The dynamic information contains updated events or information related to the pointed application.

Thus, the first aspect of the present invention provides a method for providing information in an electronic device to a user, the electronic device having a display screen for displaying messages, wherein the electronic device comprises a plurality of menu items. The method comprises:

displaying one or more menu items in different sections of the display screen so as to allow the user to highlight at least one of the displayed menu items; and

displaying on a designated area of the display screen a message indicative of the information related to the highlighted menu item in a moving pattern such that only a part of the message is displayed at a time if the entire displayed message exceeds the designated area.

When the message is shorter than or equal to the designated area, it is possible to display the message at once or in the moving pattern.

According to the present invention, the message is a text message shown in a scrolling motion.

The designated area can be substantially the same as the display screen section for displaying the highlighted menu item, or different from the display screen section for displaying the highlighted menu item.

According to the present invention, the message is indicative of updated information to show a current status, current events or future events.

According to the present invention, at least one of the displayed menu items has an associated graphical representation also displayed on the display screen. The method further comprises:

animating the graphical representation when the associated menu item is highlighted.

The second aspect of the present invention provides an electronic device having a plurality of menu items for allowing a user to access information related to the menu items. The electronic device comprises:

a display screen for displaying one ore more menu items at different sections of the display screen; and

a mechanism for allowing the user to highlight at least one of the displayed menu items, wherein when said one menu item is highlighted, a message indicative of the information related to the highlighted menu item is displayed at a designated area of the display screen in a moving pattern such that only a part of the message is displayed if the message exceeds the designated area.

However, the message can be displayed in the moving pattern even if the message is short than or equal to the designated area. Alternatively, the short message can be displayed at once.

According to the present invention, the electronic device can be a mobile phone, a communicator device, or the like.

The third aspect of the present invention provides a software product for use in an electronic device having a plurality of menu items for allowing a user to access information related to the menu items, wherein the electronic device comprises:

a display screen for displaying one or more menu items; and

a module for storing the information related to the menu items, said software product comprising:

a code for retrieving, when at least one of the menu item is highlighted by the user, the information related to said at least one menu item from the storing module; and

a code for displaying a message indicative of the retrieved information at a designated area on the display screen in a moving pattern such that only a part of the message is displayed at a time, if the message exceeds the designated area.

However, the message can be displayed in the moving pattern even if the message is short than or equal to the designated area. Alternatively, the short message can be displayed at once.

According to the present invention, one or more of the displayed menu items have associated graphical representations also displayed on the display screen, said software product further comprising:

a code for animating the graphical representation when the associated menu item is highlighted.

The present invention will become apparent upon reading the description taken in conjunction with FIGS. 1 to 10.

### BRIEF DESCRIPTION OF THE DRAWINGS

FIG. 1 is a schematic representation showing a portable electronic device having a display screen listing a plurality of application names, wherein one of which is highlighted.

FIG. 2 is a schematic representation illustrating the information related to a highlighted application name being shown on the display screen.

FIG. 3 is a schematic representation illustrating a method of showing the related information having a large amount of text.

FIG. 4 is a schematic representation showing a text message related to the “Messages” menu.

FIG. 5 is a schematic representation showing a different text message related to the “Messages” menu.

FIG. 6 is a schematic representation illustrating a different method of showing the related information.

FIG. 7 is a schematic representation illustrating an electronic device having a larger screen for listing a plurality of icons along with the application names.

FIG. 8 is a schematic representation illustrating the animation of an icon along with the showing of the related information.

FIG. 9 is a schematic representation illustrating a software program and an information storage module in the electronic device, according to the present invention.

FIG. 10 is a schematic representation illustrating how a short text message can be displayed.

### DETAILED DESCRIPTION OF THE INVENTION

Currently, when a user scrolls the menu on a display screen of a portable electronic device, such as a mobile phone, one of the listed menu items is highlighted. When the user stops scrolling, a help text associated with the highlighted menu item appears on the screen after a time-out period. If the user selects the highlighted menu item, a different display will appear on the screen to show the sub-menu associated with the highlighted menu item. If the user decides to select another menu item, the user must push a “return” button to go back to the previous screen. In some instances, the user must go into a few layers of sub-menus to reach a desired item. The user has to try out many different menu items and go into many different sub-menus.

The present invention provides a method of showing the user information pertaining to the layer lying below the displayed menu without requiring the user to select an item on the display menu. For example, if one of the menu items on a menu is “Calendar”, the user can see updated information associated with “Calendar” without actually selecting the “Calendar” application.

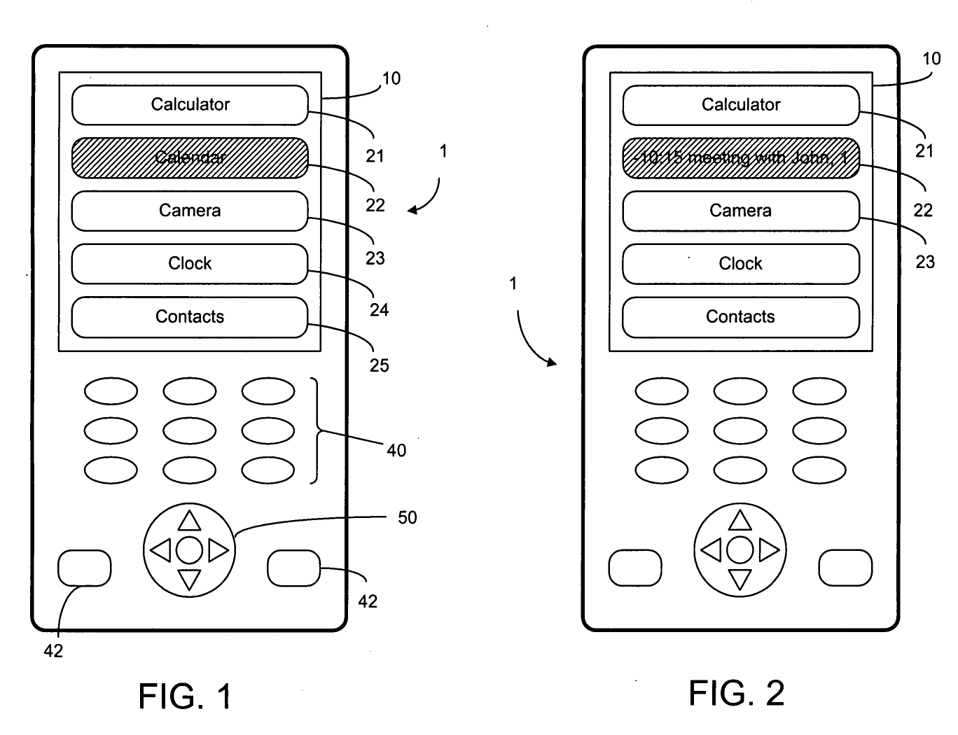

As illustrated in FIG. 1, an electronic device 1 has a screen 10 to display a menu or the like. The device 1 may have a plurality of keys 40 to allow a user to input information in the device and one or more buttons 42 to allow the user to activate a function. The device may also have a group of control keys 50 to allow the user to scroll the menu shown on the display screen 10 or to select a menu item. For illustration purposes only, the menu on the display screen 10 lists a plurality of menu items separately appearing on designated areas 21-25. When the user scrolls the menu, one of the menu items is highlighted. When the menu item is highlighted, information associated with the highlighted menu item is displayed in the same highlighted area. For example, the menu item of the highlighted area 22 is “Calendar”, information associated with “Calendar” will display in the same designated area 22.

Not all menu items have information associated thereto. For example, it is usually unnecessary to provide displayed information associated with the menu item “Calculator” if it is assumed that an average user would know what a calculator is. However, it may be helpful to display a text message such as “To launch Internet browser” when the menu item “Browser” at a designated area is highlighted. Additionally, it may be helpful to provide some detailed information about the browser, such as “XYZ Browser Version 6.3”. Furthermore, it would be helpful to provide updated information associated with certain menu items. For example, under “Calendar”, information about forthcoming events is useful. Likewise, under a menu item “Text message”, it would be helpful to show that “you have two new messages—the last one arrived Tuesday, 8:26”, for example.

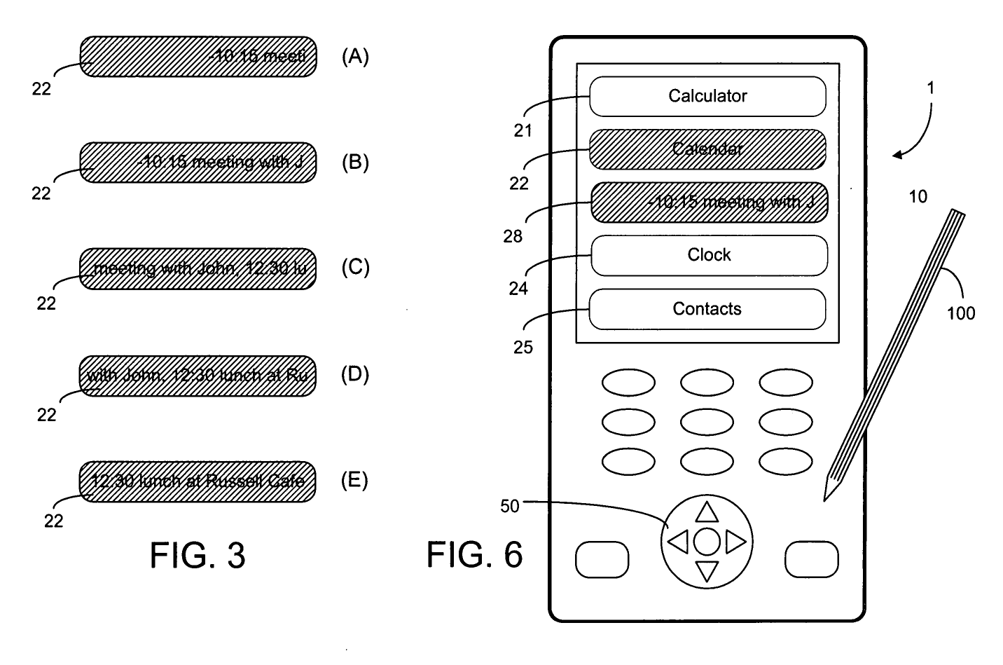

If the displayed information contains more texts than the designated area can accommodate, the displayed information will appear is a scrolling motion, more or less like a ticker tape. As shown in FIG. 2, when the designated area 22 with the menu named “Calendar” is highlighted, a text message “—10:15 meeting with John; 12:30 lunch at Russell Café” appears on the same designated area 22. Because the text message is quite long, the message must be automatically or manually scrolled through in order to show the complete text message. The scrolling motion is illustrated as a series of “moving” displayed texts 22(a)-22(e) as shown in FIG. 3.

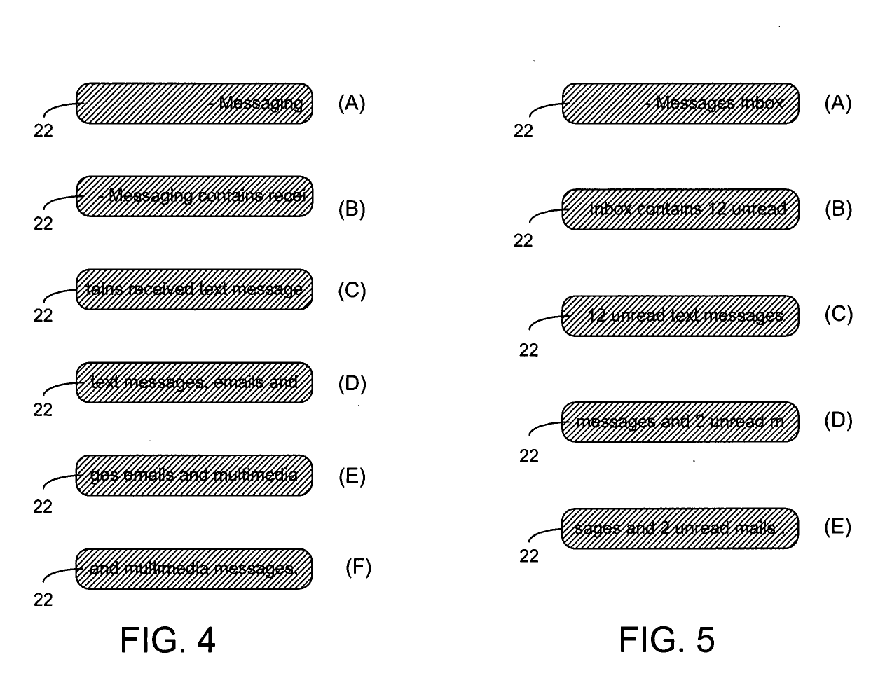

Similarly, when the menu named “Messages” is highlighted, a text message “—Messaging contains received text messages, emails and multimedia messages” to show the user the functions in connection with “messaging” appears on the designated area 22. The scrolling motion is illustrated as a series of moving displayed texts 22(a)-22(f) in FIG. 4. Alternatively, a text message “—Messages Inbox contains 12 unread text messages and 2 unread emails” appears on the designated area 22 to show the user updated information in connection with the “Messages” menu, as shown in FIG. 5.

It should be noted that the displayed texts may or may not be all the relevant information associated with the highlighted menu item. For example, under “Calendar”, the user may have many more events scheduled for later times, such as the events scheduled for the next day or later. In order to see all the scheduled events, the user may have to select the highlighted menu item to go to a different sub-menu or to start the application. Likewise, the user is required to select the highlighted menu item “Calendar” in order to enter a new calendar event.

Alternatively, the updated information can be displayed at a different area 28 of the display screen 10 as shown in FIG. 6, when the designated area 22 is highlighted. The size of the display area 28 can be smaller than, equal to, or larger than the designated area 22. As shown in FIGS. 1-6, the additional information is displayed substantially on the same screen. As such, the user is not required to select the menu item in order to reach a different menu that contains the additional information. Furthermore, it is possible to scroll the menu on the display screen 10 using an external object, such as a stylus 100.

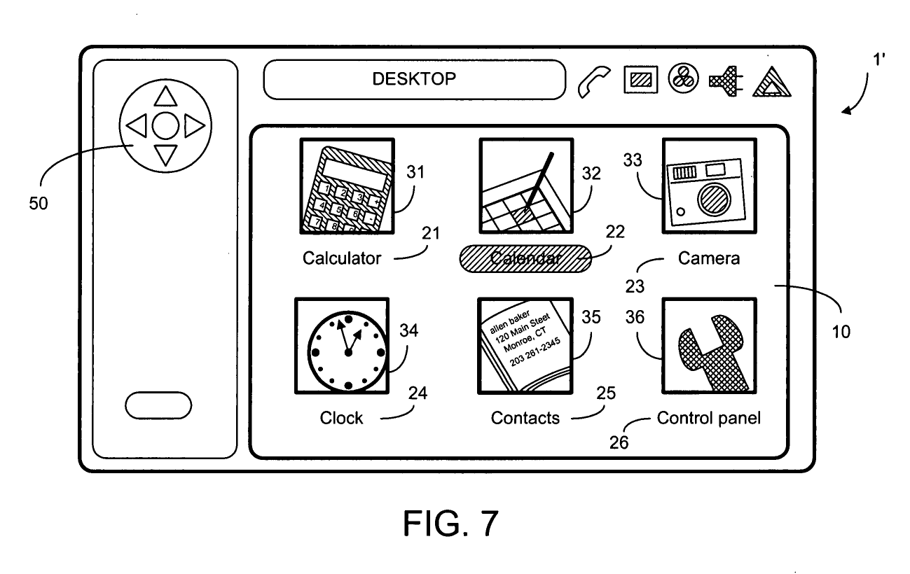

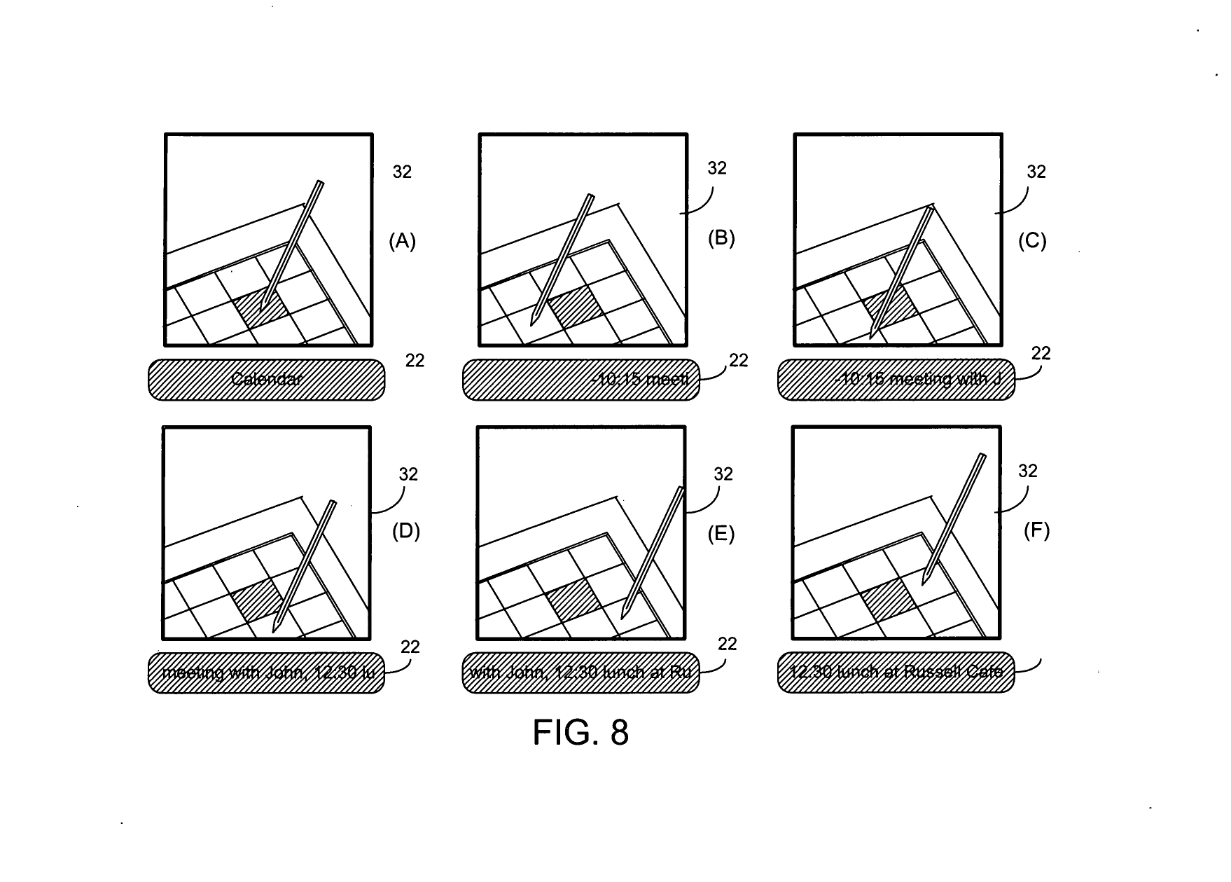

With an electronic device having a larger display screen, it is possible to display a plurality of icons along with the menu items. As shown in FIG. 7, a plurality of designated areas 31-36 are used to display icons associated with the menu items appearing at designated areas 21-26. An icon is a graphical representation associated with a menu item. In that respect, an icon is not a button that is used to execute a fuinction. As shown in FIG. 8, it is possible to animate the icon in the designated area 32 in addition to displaying in the designated area 22 information associated with the highlighted menu item “Calendar”.

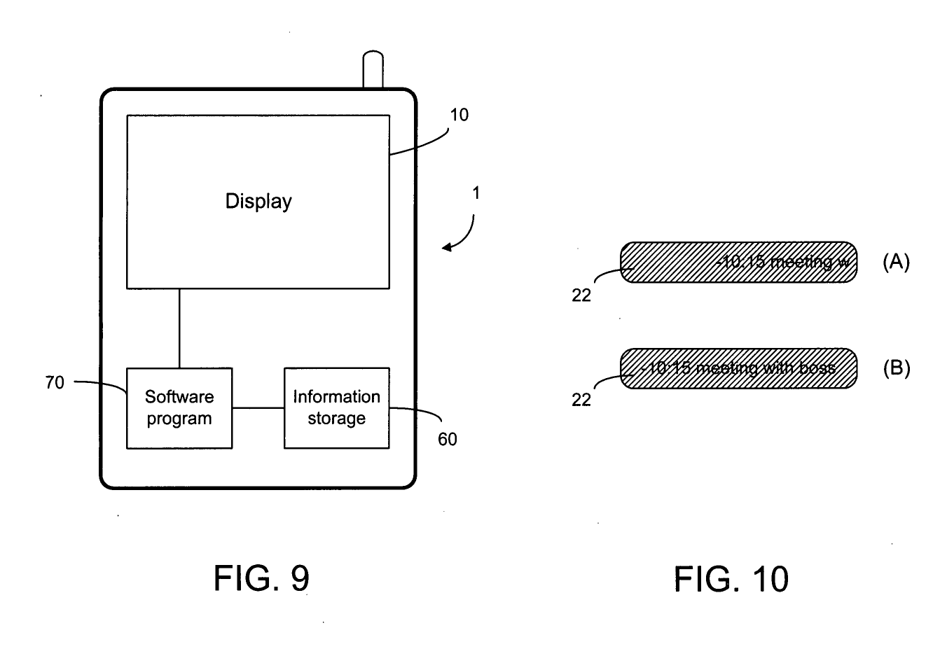

According to the present invention, the electronic device 1 comprises a module 60 for storing information and a software program 70 operatively connected to the information storing module, as shown in FIG. 9. The software program 70 comprises a code for retrieving information related to a highlighted menu item, and a code for conveying a text message indicative of the retrieved information to the display screen 10 for displaying said message in a moving pattern, if the entire message to be displayed exceeds the designated display area. The software program 70 further comprises a code for animating the icon associated with the highlighted menu item.

FIGS. 3, 4 and 5 show how a long text message is displayed in a spaced-limited display area. FIGS. 10a and 10b show how a short text message can be displayed. According to the present invention, a short text message can be displayed in a time sequence in a moving fashion as shown in both FIGS. 10a and 10b. However, the short text message can be displayed at once in a non-moving fashion, as illustrated in FIG. 10b alone.

In sum, the present invention provides a method of showing information related to an item in the menu without requiring the user to select the menu item. The text message indicative of the information can be shown in a moving pattern over a designated section of the display screen such that only a part of the text message is displayed at a time, especially when the required area for displaying the entire text message exceeds the designated section. Preferably, the information is updated to reflect the current status of a highlighted menu item or the forthcoming events related to the highlighted menu item. It is desirable to animate an icon associated with the highlighted menu item when the information is displayed.

The electronic device 1, as shown in FIGS. 1 and 2, can be a hand-held device such as a mobile phone, a communicator, a personal digital assistant (PDA) or the like.

It should be noted that, the term “highlighted” as used in conjunction with the present invention does not necessarily mean “black” or “white” or a particular color on the display screen. It is intended to mean a different color or shade or pattern on the display screen so as to distinguish the “highlighted” area from at least some of the other areas on the display screen. For example, when a menu item is highlighted, the size or the color of the font of the menu item can be changed, or the background color can be changed. The font or the background can be turned on and off to show a blinking effect. It is also possible to put a frame around the “highlighted” menu item. In other words, a “highlighted” area is visibly distinguishable from a “non-highlighted” area.

Thus, although the invention has been described with respect to a preferred embodiment thereof, it will be understood by those skilled in the art that the foregoing and various other changes, omissions and deviations in the form and detail thereof may be made without departing from the scope of this invention.

1. A method for providing information in an electronic device to a user, the electronic device having a display screen for displaying messages, wherein the electronic device comprises a plurality of menu items, said method comprising:
displaying one or more menu items in the display screen so as to allow the user to highlight at least one of the displayed menu items; and
displaying on a designated area of the display screen a message indicative of the information related to the highlighted menu item in a moving pattern such that only a part of the message is displayed at a time in a time sequence.

2. The method of claim 1, wherein the message is displayed in the moving pattern only if the message exceeds the designated area.

3. The method of claim 2, wherein the message is displayed at once if the message is shorter or equal to the designated area.

4. The method of claim 1, wherein the message is displayed in the moving pattern even if the message is shorter than or equal to the designated area.

5. The method of claim 1, wherein the message is a text message shown in a scrolling motion.

6. The method of claim 1, wherein the designated area is substantially the same as the display screen section for displaying the highlighted menu item.

7. The method of claim 1, wherein the designated area is different from the display screen section for displaying the highlighted menu item.

8. The method of claim 1, wherein the message is indicative of the updated information to show current events.

9. The method of claim 1, wherein the message is indicative of the updated information to show future events.

10. The method of claim 1, wherein at least one of the displayed menu items has an associated graphical representation also displayed on the display screen, said method further comprising:
animating the graphical representation when the associated menu item is highlighted.

11. An electronic device having a plurality of menu items for allowing a user to access information related to the menu items, said electronic device comprising:
a display screen for displaying one or more menu items; and
a mechanism for allowing the user to highlight at least one of the displayed menu items, wherein when said one menu item is highlighted, a message indicative of the information related to the highlighted menu item is displayed at a designated area of the display screen in a moving pattern such that only a part of the message is displayed at a time in a time sequence.

12. The electronic device of claim 11, where the message is displayed in the moving pattern only if the message exceeds the designated area.

13. The electronic device of claim 12, wherein the message is displayed at once if the message is shorter or equal to the designated area.

14. The electronic device of claim 11, wherein the message is displayed in the moving pattern even if the message is shorter than or equal to the designated area.

15. The electronic device of claim 11, wherein the message is a text message shown in a scrolling motion.

16. The electronic device of claim 11, wherein the designated area is substantially the same as the display screen section for displaying the highlighted menu item.

17. The electronic device of claim 11, wherein the message is indicative of the updated information to show current events.

18. The electronic device of claim 11, wherein the message is indicative of the updated information to show future events.

19. The electronic device of claim 11, comprising a mobile terminal.

20. The electronic device of claim 11, comprising a communicator device.

21. A software product for use in an electronic device having a plurality of menu items for allowing a user to access information related to the menu items, wherein the electronic device comprises:
a display screen for displaying one or more menu items; and
a module for storing the information related to the menu items, said software product comprising:
a code for retrieving, when at least one of the menu item is highlighted by the user, the information related to said at least one menu item from the storing module; and
a code for displaying a message indicative of the retrieved information at a designated area on the display screen in a moving pattern such that only a part of the message is displayed at a time in a time sequence.

22. The software product of claim 21, wherein the displaying code displays the message in the moving pattern only if the message exceeds the designated area.

23. The software product of claim 22, wherein the displaying code displays the message at once if the message is shorter or equal to the designated area.

24. The software produce of claim 21, wherein the displaying code displays the message in the moving pattern even if the message is shorter or equal to the designated area.

25. The software product of claim 21, wherein the moving pattern is a scrolling motion pattern.

26. The software product of claim 21, wherein one or more of the displayed menu items have associated graphical representations also displayed on the display screen, said software product further comprising:
a code for animating the graphical representation when the associated menu item is highlighted.
